(19) United States
(12) Patent Application Publication
(10) Pub. No.: US 2017/0300979 A1
(43) Pub. Date: Oct. 19, 2017

(54) Unitised Asset Insurance Method and System

(71) Applicant: Insurance Australia Limited, Sydney (AU)

(72) Inventors: Gopal RAMAN, West Pennant Hills (AU); Ron ARNOLD, Sydney (AU); Samuel DAY, Bondi Beach (AU)

(21) Appl. No.: 15/209,407

(22) Filed: Jul. 13, 2016

(30) Foreign Application Priority Data
Apr. 19, 2016 (AU) 2016 202476

(51) Int. Cl. G06Q 30/02; G06Q 40/08; G06Q 40/02

(52) U.S. Cl. CPC G06Q 30/0283; G06Q 40/025; G06Q 40/08

(57) ABSTRACT

A method and system of pricing an insurance product covering an asset, are provided. The method comprises receiving a request from a user for an insurance product, the request specifies at least an identification information for the asset, and an insurance time period of at least one unit of time during which the asset will be loaned; calculating a unitised price for the insurance product, based on the information in the request, for a unit of time; and displaying a price for the insurance product to the user for the insurance time period.

### FIELD OF THE INVENTION

The present invention relates to computerised methods and systems for insuring assets.

### BACKGROUND OF THE INVENTION

Valuable assets are frequently insured against loss or damage, as a form of risk management. A person can buy an insurance policy from an insurance company covering the asset, and pay an annual premium for the insurance policy. In the event that the asset is lost or damaged, the insurance company will pay the replacement or repair costs.

There are many factors that go into assessing the cost of an insurance premium. These include the value of the asset, its age, its location (which may put the asset at higher risk of certain types of loss or damage), and its security features (for example, security features on doors and windows of a house).

Insurance companies are familiar with weighing each of these factors to determine the insurance premium of an insurance policy. However, recently there has been a shift in the way assets are utilised, with the rise of the sharing economy. In a sharing economy, assets are loaned or hired out for short periods where they would otherwise be unused, which affects the risk associated with an insurance policy. Insurance companies, however, have continued to calculate an insurance premium based on traditional risk factors. Furthermore, current insurance policies are unclear on if they provide cover when a person uses their personal asset (e.g. home) for commercial purposes. In some instances, there is a clear gap (e.g. malicious damage) and in other cases it is grey or subject to interpretation (e.g. liability).

There is a need for systems and methods which better meet the needs of a modern sharing economy.

### SUMMARY OF THE INVENTION

According to an aspect of the present invention, there is provided a method of costing an insurance product covering an asset, the method comprising:

receiving a request from a user for pricing of an insurance product, the request specifying at least:
identification information for the asset, and
an insurance time period of at least one unit of time during which the asset will be loaned;

calculating a unitised price for the insurance product, based on the information in the request, for a unit of time; and

displaying a price for the insurance product to the user for the insurance time period.

The present invention addresses difficulties associated with short term rental of assets. For example, a guest room may be rented out on AirBNB, or a bicycle may be loaned for a matter of days or hours. By calculating a unitised price for the insurance product (for example, per day or per hour), and extrapolating this over the loan time period, loans of varying time can be easily accommodated.

For the purposes of the present specification, the term ‘loan’ includes both the borrowing of portable assets, or the use of fixed assets (such as a house or room) by a guest for a loan time period.

The method may further comprise specifying a recognised platform through which the asset will be loaned. The recognised platform may be contacted to verify that a loan agreement for the asset has been facilitated by the recognised platform. This helps ensure that the insurance product is only used for genuine loan transactions. The recognised platform may be an asset sharing platform.

The method may further specify a number of persons to whom the asset will be loaned. This may also be taken into account when calculating the unitised price of the insurance product.

The method may further include one or more person identifiers to identify the one or more persons to whom the asset will be loaned. The recognised platform may be contacted to obtain a rating for those person(s), which can be used to calculate the price of the insurance product.

Accordingly, the present invention reduces the risk of participation in the shared economy, and provides legitimacy and transparency to users who wish to share their assets. Users are given peace of mind should something go wrong. Gaps in cover offered by the recognised sharing platform, such as liability, loss of rental income, and valuables cover may be addressed by the present invention. This reduces exposure of users should loss or damage occur to one of their largest assets (e.g. their home).

The present invention also enables insurers to leverage the significant growth in the shared economy.

According to a further aspect of the present invention, there is provided a computer-implemented system for pricing an insurance product, said system comprising one or more computers including:

at least one processor; and

at least one storage medium operatively coupled to said processor, said storage medium containing program instructions for execution by said processor, said program instructions causing said processor to execute the steps of the above method(s).

According to a still further aspect of the present invention, there is provided a tangible computer-readable medium having computer-executable instructions stored thereon for directing a programmable device to perform the above method, or any of the computer-implemented methods described herein.

The system may also provide for access to the method of pricing an insurance product covering an asset to other external insurance parties through facilitation of the user request, execution of the pricing method and transfer of the insurance request information and pricing to an external insurance party.

A detailed description of one or more embodiments of the invention is provided below, along with accompanying figures that illustrate by way of example the principles of the invention. While the invention is described in connection with such embodiments, it should be understood that the invention is not limited to any embodiment. On the contrary, the invention encompasses numerous alternatives, modifications and equivalents.

For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF DRAWINGS

FIG. 1 is a schematic block diagram of a computer-implemented system for pricing an insurance product, in accordance with a representative embodiment of the present invention.

FIGS. 2 and 3 are screenshots showing information that may be provided by a user in a request for pricing of an insurance product.

FIG. 4 depicts a calculated insurance product price.

FIG. 5 depicts a technology stack for a system according to an embodiment of the present invention

### DETAILED DESCRIPTION

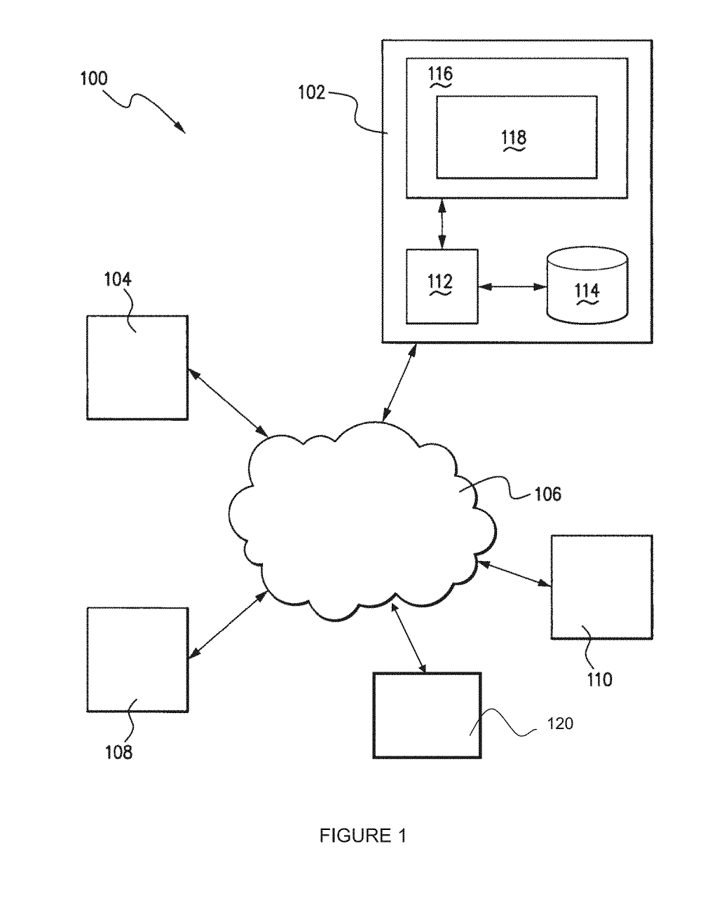

FIG. 1 illustrates an exemplary system 100 in which preferred embodiments of the invention may be implemented. The system includes a server 102 and at least one user terminal 104, both of which are connected to a network 106, which may be, for example, the Internet. Also connected to the network 106 are a plurality of user terminals and/or servers, e.g. 108, 110. It will be appreciated that FIG. 1 depicts the system 100 schematically only, and is not intended to limit the technology employed in the servers, user terminals and/or communication links. The user terminals in particular may be wired or wireless devices, and their connections to the network may utilize various technologies and bandwidths. For example, applicable user terminals include (without limitation): PC's with wired (e.g. LAN, cable, ADSL, dial-up) or wireless (e.g. WLAN, cellular) connections; and wireless portable/handheld devices such as PDA's, tablet computers including Apple iPads, or mobile/cellular telephones and smartphones. These devices also may include input means, such as a mouse and keyboard, stylus or other pointing device or system, or a touch screen, to enable the users to make selections and input data. The protocols and interfaces between the user terminals and the servers may also vary according to available technologies, and include (again without limitation): wired TCP/IP (Internet) protocols; GPRS, WAP and/or 3G protocols (for handheld/cellular devices); Short Message Service (SMS) messaging for digital mobile/cellular devices; and/or proprietary communications protocols.

The server 102 includes at least one processor 112 as well as at least one database 114, which would typically be stored on a secondary storage device of the server 102, such as one or more hard disk drives. Server 102 further includes at least one storage medium 116, typically being a suitable type of memory, such as random access memory, for containing program instructions and transient data related to the operation of the system as well as other necessary functions of the server 102. In particular, memory 116 contains a body of program instructions 118 implementing the method and system in accordance with preferred embodiments of the invention. The body of program instructions 118 includes instructions for managing delivery of orders, the operation of which will be described hereafter. It should be appreciated in relation to the configuration of the server 102 that one or more of the database 114, storage medium 116, and body of program instructions 118, may be provided at a remote location (such as for a cloud computing configuration).

The user terminals may each include at least one processor, a storage medium, and program instructions for performing methods according to embodiments of different aspects of the present invention.

An external insurer server 120 may also connect to server 102 via network 106.

It should be appreciated that the hardware used to implement the method of the invention may be conventional in nature or specifically designed for the purpose. The hardware structure shown in FIG. 1 is merely one possible embodiment and any other suitable structure may be utilised.

Initially, a user (using a user terminal 108) may contact the server 102 via the Internet, to indicate interest in an insurance policy. In this embodiment, the asset to be insured is a house, which the user wishes to share on a recognised sharing platform such as AirBNB or Stayz. However, the present invention may be adapted for different types of assets (e.g. bicycles, cars, caravans, tools, individual rooms of a building) and different sharing platforms, where personal assets are also used for a commercial purpose.

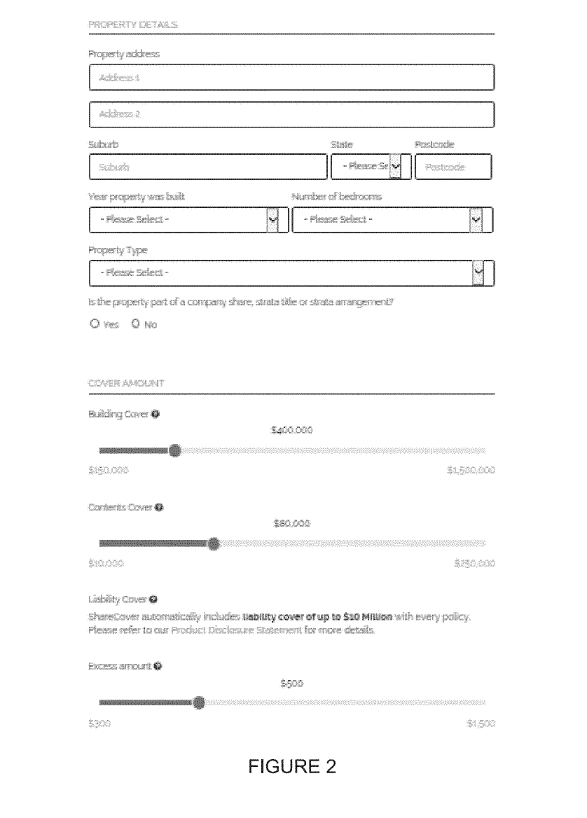

The server 102 may respond with a web form for the user to fill out, specifying various factors relevant to the insurance policy. These factors may include traditional factors such as identification information (eg address), the type of property and its age, the value of the property (or the value to be covered by the insurance policy), and the excess payable in the event of a claim. FIG. 2 depicts this portion of a web form, prompting the user to provide these factors.

However, the web form may also prompt the user to specify loan or rental details—for example, specific time period, the platform over which the property is being shared, the number of guests staying at the property, and an indication of whether the owner will be staying at the property at the same time as the guest(s). FIG. 3 depicts this portion of a web form, prompting the user to provide these factors.

In addition, the user may be prompted to provide names and identifying details of the guest(s). Alternatively, instead of requiring the user to provide guest identification details, the user may provide a transaction reference from the recognised sharing platform, allowing the server 102 to contact the platform and obtain information regarding the guest(s).

Once the web form has been completed, the information is transmitted to the server 102 (which may be resident on a Cloud platform and utilised using a published API), and the server 102 calculates a price for the insurance product. One feature of a sharing request is that it may be for a varying number of days. Accordingly, in this embodiment of the present invention, the server 102 will calculate a unitised (daily) price, and extrapolate that to the full term of the loan (ie rental agreement).

In relation to some traditional factors, such as location of the asset, its value, and the excess payable on a claim, these can influence the price in conventional ways associated with the usual risks of fire damage, water damage. However, for some risks, the risk associated with sharing an asset in this way is atypical—for example, the risk of theft or malicious damage is higher than usual, because the guest (a stranger) has been invited into the home, and ordinary security measures are not relevant. These risks should be weighed accordingly when calculating the final insurance price.

Specifically, in relation to guests where the server 102 has obtained guest information, the server 102 can then determine a rating for those guests—either based on information in a database on the server 102, collected from providing previous insurance products, or by contacting the recognised platform to obtain information relevant to that guest. This may include past history of the guest(s) (ie have complaints been made previously?), or star ratings provided by other users of the platform who have interacted with the guest(s). Collectively, these factors may be used to determine an external certification rating, which provides information about the interactions by the host and guest on the recognised sharing platform. A guest (and indeed a host) can be categorised as high or low risk based on this rating.

For example, the sharing platform may provide a rating for the host, and a rating for the guest to the server 102, based on its own internal weighting algorithms. Each rating value could be associated with an insurance rating (points), which is then input into the underwriting engine that outputs the product pricing, so as to effectively price the insurance risk.

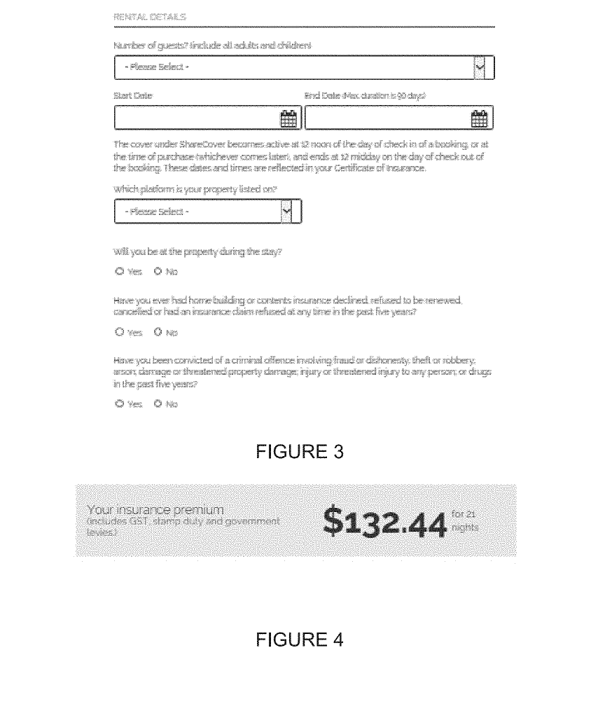

The price can then be transmitted from the server 102 to the user terminal 108, and displayed to the user as depicted in FIG. 4. At this point, in some embodiments, the user may be able to agree to the proposed pricing and request that the insurance product be provided. Payment may be made over the Internet.

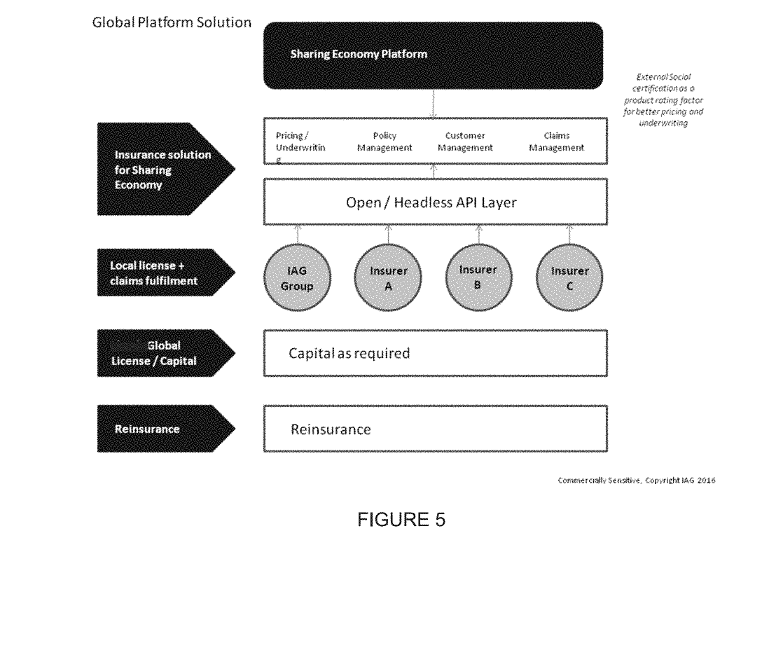

The price and underwriting information can then be transmitted from the server 102 to an external insurance provider server 120, for underwriting of the risk. At this point, the external insurance provider may be able to provide confirmation back to the recognised sharing platform. FIG. 5 depicts the technology stack according to an embodiment of the present invention, enabling multiple external insurer servers to access the pricing engine.

The word ‘comprising’, and forms of the word ‘comprising’, when used in this specification is taken to specify the presence of stated features, integers, steps or components but does not preclude the presence or addition of one or more other features, integers, steps, components or groups thereof.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

The claims defining the invention are as follows:

1. A method of pricing an insurance product covering an asset, the method comprising:
receiving a request from a user for pricing of an insurance product, the request specifying at least:
identification information for the asset, and
an insurance time period of at least one unit of time during which the asset will be loaned;
calculating a unitised price for the insurance product, based on the information in the request, for a unit of time; and
displaying a price for the insurance product to the user for the insurance time period.

2. The method of claim 1, wherein the request further specifies a recognised platform through which the asset will be loaned.

3. The method of claim 2, further including:
verifying with the recognised platform that a loan agreement for the asset has been facilitated by the recognised platform.

4. The method of claim 1, wherein the request further specifies a number of persons to whom the asset will be loaned.

5. The method of claim 2, wherein the request further specifies a number of persons to whom the asset will be loaned.

6. The method of claim 3, wherein the request further specifies a number of persons to whom the asset will be loaned.

7. The method of claim 1, wherein the request further specifies one or more person identifiers to identify the one or more persons to whom the asset will be loaned.

8. The method of claim 2, wherein the request further specifies one or more person identifiers to identify the one or more persons to whom the asset will be loaned.

9. The method of claim 3, wherein the request further specifies one or more person identifiers to identify the one or more persons to whom the asset will be loaned.

10. The method of claim 4, wherein the request further specifies one or more person identifiers to identify the one or more persons to whom the asset will be loaned.

11. The method of claim 5, wherein the request further specifies one or more person identifiers to identify the one or more persons to whom the asset will be loaned.

12. The method of claim 6, wherein the request further specifies one or more person identifiers to identify the one or more persons to whom the asset will be loaned.

13. The method of claim 8, further including contacting the recognised platform to determine a rating for the one or more persons, and wherein the rating is used to calculate the premium.

14. The method of claim 9, further including contacting the recognised platform to determine a rating for the one or more persons, and wherein the rating is used to calculate the premium.

15. The method of claim 13, wherein the request and the calculated unitised price for the insurance product are provided to an external insurance provider with whom the recognised platform for facilitating the loan agreement has an arrangement.

16. The method of claim 14, wherein the request and the calculated unitised price for the insurance product are provided to an external insurance provider with whom the recognised platform for facilitating the loan agreement has an arrangement.

17. A computer-implemented system for pricing an insurance product, said system comprising one or more computers including:
at least one processor, and
at least one storage medium operatively coupled to said processor, said storage medium containing program instructions for execution by said processor, said program instructions causing said processor to execute the steps of claim 1.

18. A tangible computer-readable medium having computer-executable instructions stored thereon for directing a programmable device to perform the method of claim 1.
